(19) United States
(12) Patent Application Publication
(10) Pub. No.: US 2006/0285808 A1
(43) Pub. Date: Dec. 21, 2006

(54) Light-guiding system comprising a plate-like triangular guiding member

(75) Inventors: Ludovicus J. L. Haenen, Eindhoven (NL); Johannes Petrus Maria Ansems, Eindhoven (NL); Nicola Bettina Pfeffer, Eindhoven (NL); Edwin Van Lier, Eindhoven (NL); Augustinus Gregorius Henricus Meijers, Eindhoven (NL); Augustinus Gregorius Henricus Meijers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,870

(22) PCT Filed: Aug. 19, 2004
(86) PCT No.: PCT/IB04/51493

§ 371 Date: Mar. 7, 2006

(30) Foreign Application Priority Data
Sep. 8, 2003 (EP) 031033145

(51) Int. Cl. G02B 6/04

(52) U.S. Cl. 385/121; 385/146

(57) ABSTRACT

A light-guiding system comprising a plate-like light-guiding element (20) having a substantially flat lateral surface and means for coupling in light through said lateral surface. Said means comprise a light-guiding member (1,21) substantially having a flat platelike and triangular shape, wherein a shorter side (2) comprises light-coupling means (5) for coupling in light into said light-guiding member (1,21). A longer side of the triangle comprises a coupling-out surface (7) which faces said lateral surface for coupling in light into said light-guiding element (20). The third side (8) of the triangle comprises a number of surfaces (10) that are positioned at an angle to the direction of said third side (8).

The invention relates to a light-guiding system comprising a plate-like light-guiding element having a substantially flat lateral surface and means for coupling in light through said lateral surface.

Such a system is disclosed in US-A-2002/0167820. This publication describes a light-guiding system for improving the lighting conditions of the passenger compartment of a motor vehicle, wherein a plate-like light-guiding element is arranged in the area of the interior lining of the vehicle roof. Light is coupled in into the light-guiding element through one or more lateral surfaces of the light-guiding element, and light is emitted through the large front surface of the light-guiding element into the passenger compartment of the vehicle in a homogeneous manner. The light is coupled in into the light-guiding element by means of a light-generating unit, such as a fluorescent tube, extending along the lateral surface of the light-guiding element.

Appropriate materials for guiding light are transparent thermoplastics, in particular polymethyl methacrylate (PMMA) or polycarbonate (PC). Such materials can be shaped, for example, by an injection molding process, by an extrusion process, or by a material-removing laser operation.

When light is coupled in into a plate-like light-guiding element through an oblong lateral surface, a relatively long light source is required, which light source may be longer than an efficiently operating light source. It may be desired also for other reasons to generate the light by means of a light source smaller than the dimensions of the lateral surface of the plate-like light-guiding element.

The object of the invention is to provide means for coupling in light through a lateral surface of a plate-like light-guiding element such that light from a relatively small light source can be distributed over a larger surface of the light-guiding element.

In order to accomplish that objective, said means comprise a light-guiding member substantially having a flat plate-like and triangular shape, wherein a shorter side of the triangle comprises light-coupling means for coupling in light into said light-guiding member, wherein a longer side comprises a coupling-out surface which faces said lateral surface for coupling in light into said light-guiding element, and wherein the third side of the triangle comprises a number of surfaces that are positioned at an angle to the direction of said third side, all said surfaces being perpendicular to the plane of said plate-like shape. Each surface of the number of surfaces is positioned such that the light coming from said light-coupling means is reflected to said coupling-out surface, so that the light can be directed to said longer side in the desired direction and in accordance with a desired distribution of the light each of said surfaces is given an appropriate orientation, i.e. an appropriate direction.

In one preferred embodiment, the plate-like light-guiding member has a substantially right-angled triangular shape, wherein said shorter side and said longer side of the triangle enclose the substantially right angle, and wherein said third side is the hypotenuse of the triangle, which side comprises said number of surfaces, said surfaces being positioned at an angle of about 45° to said coupling-out surface. Preferably, said third side comprises a number of surfaces having alternating directions, at said angle to the direction of said third side and substantially perpendicular to said shorter side, respectively. All these surfaces may be flat or may be curved so as to achieve the desired distribution of the light at the coupling-out surface.

Depending on the refractive index of the material of the light-guiding member, the light will be reflected back into the light-guiding member by the surfaces of that member. A light beam will be reflected if the angle of incidence is greater than a certain value, i.e. than the angle of total reflection. (The angle of incidence is the angle between the light beam and a line perpendicular to the surface to which the light beam is directed.)

In the case of a right-angled triangular shape, the main direction of the light coupled in by said light-coupling means has a direction parallel to said coupling-out surface. The surfaces at an angle of 45° will then reflect the light beams to the coupling-out surface in a direction mainly perpendicular to that surface, so that the light will be coupled out.

The light-guiding member functions as an intermediate light guide, wherein the shorter side of the triangle can be made as short as is required to make use of appropriate light-coupling means and the longer side may have a length corresponding to the length of the oblong lateral surface of the plate-like light-guiding element. The number of surfaces at a certain angle along the third side of the triangle is preferably more than six, more preferably more than twelve.

In one preferred embodiment, at least said surfaces positioned at an angle to said third side are provided with a light-reflecting material. All surfaces of the light-guiding member, except for the coupling-out surface, may be provided with a light-reflecting coating to increase the reflection of light if the surface is not smooth enough to reflect all light having an angle of incidence greater than the angle of total reflection, or if there are light beams having an angle of incidence smaller than the angle of total reflection, or if there are light beams having an angle of indicence smaller than the of total reflection. Such a coating may also protect the relevant surfaces from undesired optical contact with other materials.

Preferably, the light-guiding member has a thickness between 0.5 mm and 15 mm, more preferably between 2 mm and 7 mm, which thickness preferably corresponds to the thickness of said light-guiding element. In general, the thickness of the light-guiding member is smaller than the length of said shorter side of said triangle, preferably less than half, more preferably less than one fourth, and in a preferred embodiment less than on tenth thereof.

In one preferred embodiment, at least a portion of one or both surfaces of said light-guiding member, which surfaces are parallel to said plane, are provided with a coating of material having a lower refractive index than the material of the light-guiding member itself. Such a coating, or cladding, prevents the surface of the light-guiding material from being contacted by material such as a glue, or from becoming dirty, for example by fingerprints.

Preferably, said light-coupling means for coupling in light into said light-guiding member comprise a number of light transmission rods, each of said light transmission rods having an end which is connected to a lateral surface of the light-guiding member, which surface is located at said shorter side of said triangle. The light transmission rods may be made of the same light-guiding material as the material of the light-guiding member and preferably have a diameter between 0.2 mm and 5 mm, more preferably between 1 mm and 3 mm.

In one preferred embodiment, the light transmission rods are, near said lateral surface, positioned parallel to each other in a plane perpendicular to said lateral surface of the light-guiding member. Preferably, the distance between said rods, near said surface, is less than 5 mm. There may be no space at all between the rods, but preferably the distance is between 1 mm and 2 mm.

Preferably, the other ends of the light transmission rods are bound together so as to form a member for coupling in light into said light transmission rods. Preferably, said member has a substantially cylindrical shape, so that light can be coupled in by a relatively small light source. However, other shapes are also possible.

To connect the light transmission rods to the lateral surface of the light-guiding member, said surface may be provided with bores in which the light transmission rods fit. The flat end surface of the light transmission rod thus faces the flat bottom of the bore, so that the light beams can pass both surfaces, and only a small loss of light will occur.

In one preferred embodiment, said light-guiding member and said light transmission rods are one piece of the same material. They are preferably produced in a single injection molding operation. Then the light can be guided from a light source through the light transmission rods and the light-guiding member without any interruption, i.e. without passing any surface, so that loss of light is limited.

In one preferred embodiment, said plate-like light-guiding element has means for emitting light through at least a part of its front surface. Such means for emitting light are described in US-A-2002/0167820. It may be a rear side of the light-emitting element structured by roughening, embossing or boring of the material. Another possibility is the introduction of scattering centers, such as refractive pigments, in the material of the light-emitting element.

Preferably, at least a portion of the front side and/or the rear side of the plate-like light-guiding element is provided with a coating having a lower refractive index than the material of the light-guiding element itself. Such a coating, or cladding, prevents the surface of the light-guiding material from being contacted by material such as glue, or from becoming dirty, for example by fingerprints.

For example, such a cladding makes it possible to attach a fabric against the front surface of the light-guiding element by means of glue, so that the light can shine through the fabric. Furthermore, the light-guiding element may be fixed by means of glue when being mounted.

In one preferred embodiment, said light-guiding element and said light-guiding member are one piece of the same material, said element and said member each extending at a side of a flat plane, such that one or more interstices, lying in said plane and extending over at least a major portion of said coupling-out surface, is/are present between said lateral surface of said light-guiding element and said coupling-out surface of said light-guiding member. An interstice is defined as a space between two substantially parallel surfaces. The presence of one or more interstices containing air ensures that the light is coupled in into the light-guiding element in the correct direction, mainly in a direction perpendicular to said lateral surface of the light-guiding element. Light beams having too large an angle of incidence on said coupling-out surface will not be coupled out, but will be reflected back into the light-guiding member.

The combination of the light-guiding member and the light-guiding element may be made at an injection molding operation, wherein the light transmission rods can be made in the same time, so that the assembly containing all light-guiding means is of one piece of material. Light can thus be guided from the light source to the location of emission without losing much of the light. The interstices may be made during the injection molding operation, but they may also be made afterwards, for example by a material removing operation with a laser beam.

The invention also relates to a light-guiding member as described above comprising a substantially flat plate-like and triangular shape, wherein a shorter side comprises light-coupling means for coupling in light into said light-guiding member, wherein a longer side comprises a coupling-out surface which may face a surface for coupling in light into a light-guiding element, and wherein the third side of the triangle comprises a number of surfaces being positioned at an angle to the direction of said third side, all said surfaces that are perpendicular to the plane of said plate-like shape.

Furthermore, the invention relates to a method of guiding light into a plate-like light-guiding element having a flat lateral surface, wherein light is coupled in through said lateral surface by a light-guiding member substantially having a flat plate-like and triangular shape, wherein light is coupled in into said light-guiding member through a shorter side of the triangle by light-coupling means, wherein a longer side of the triangle comprises a coupling-out surface which faces said lateral surface for coupling in light into said light-guiding element, and wherein the third side of the triangle comprises a number of surfaces that are positioned at an angle to the direction of said third side, all said surfaces being perpendicular to the plane of said plate-like shape, so that the light from the light-coupling means is reflected by the surfaces at an angle to the direction of the third side and is thus directed to said coupling-out surface and coupled in into said light-guiding element.

The invention will now be further elucidated by means of a description of some embodiments of a light-guiding system, for which reference is made to the drawing comprising Figures which are only schematic representations, where:

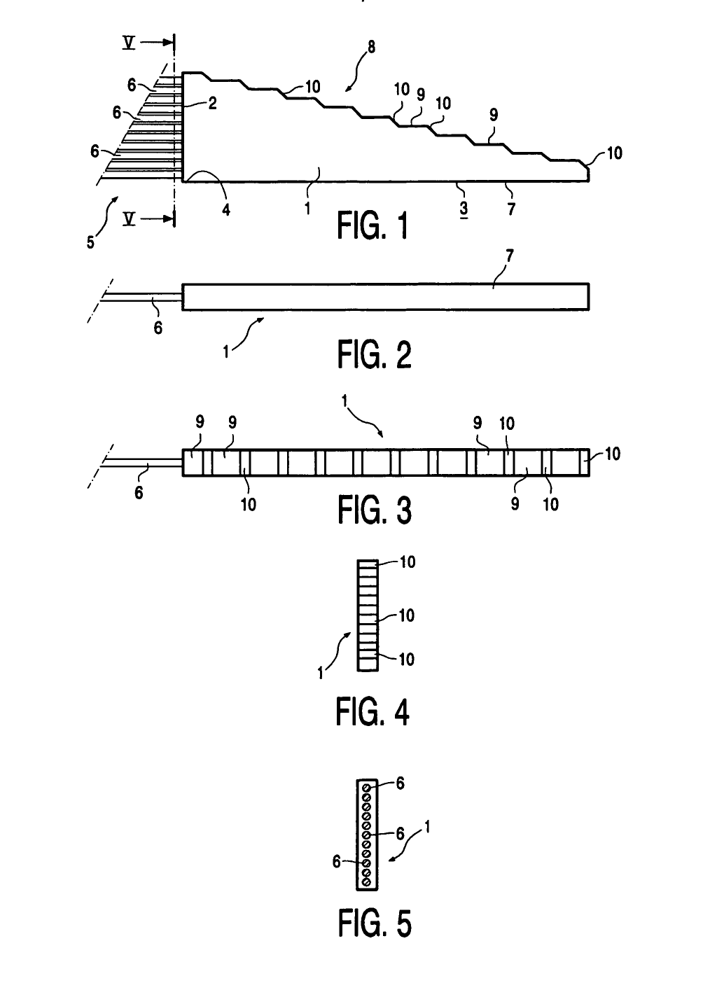

FIG. 1 is a top view of a plate-like triangular light-guiding member,

FIG. 2 shows the light-guiding member viewed from the lower side in FIG. 1;

FIG. 3 shows the light-guiding member viewed from the upper side in FIG. 1;

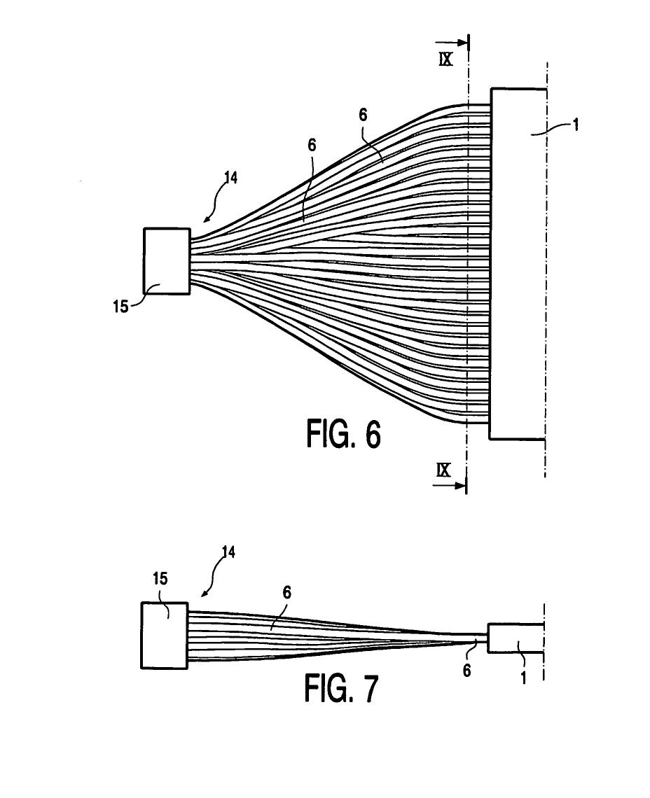

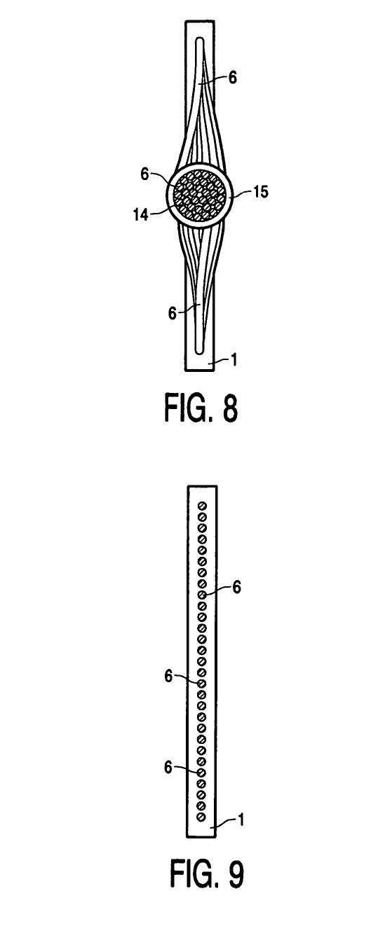

FIG. 4 shows the light-guiding member viewed from the right-hand side in FIG. 1;

FIG. 5 is a sectional view taken on the line V-V in FIG. 1;

FIG. 6 is a top view of a light guide comprising light transmission rods;

FIG. 7 shows the light guide viewed from the lower side in FIG. 6;

FIG. 8 shows the light guide viewed from the left-hand side in FIG. 6;

FIG. 9 is a sectional view taken on the line IX-IX in FIG. 6;

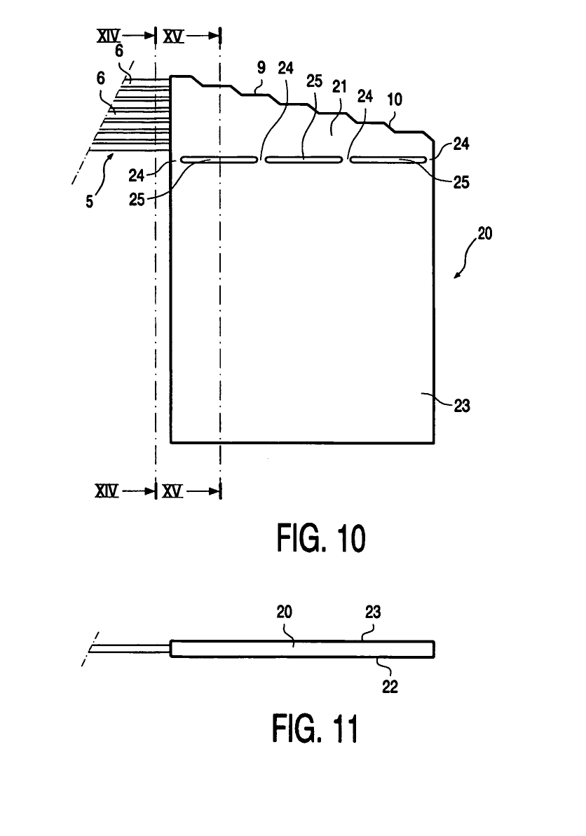

FIG. 10 is a top view of a system for guiding and emitting light;

FIG. 11 shows the system viewed from the lower side in FIG. 10;

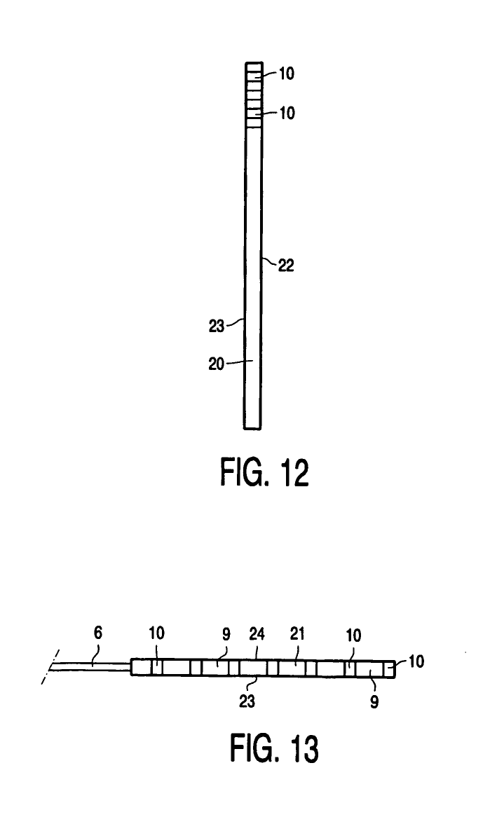

FIG. 12 shows the system viewed from the right-hand side in FIG. 10;

FIG. 13 shows the system viewed from the upper side in FIG. 10;

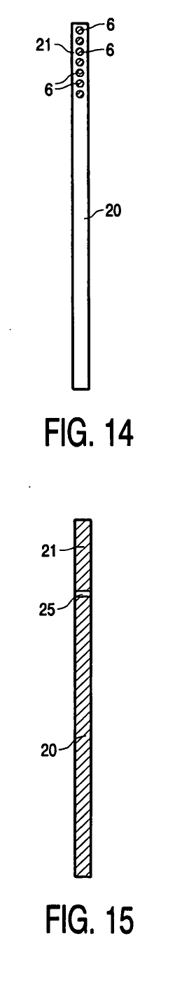

FIG. 14 is a sectional view taken on the line XIV-XIV in FIG. 10; and

FIG. 15 is a sectional view taken on the line XV-XV in FIG. 10.

FIG. 1 shows a plate-like and substantially triangular light-guiding member 1. In this example of an embodiment, the material of the light-guiding member 1 is polycarbonate, which is a transparent thermoplastic material that can be shaped by means of an injection molding operation. The outer surfaces of the product that is produced by the injection molding operation are smooth, so that light that is coupled in will be reflected by said surfaces, provided that the angle of incidence with respect to the relevant surface is greater than the angle of total reflection (i.e. the critical angle of total reflection). The angle of total reflection depends on the value of the refractive index of the material of the light-guiding member and the value of the refractive index of the medium bordering the relevant surface of the light-guiding member.

The refractive index of polycarbonate is about 1.6 and the refractive index of air is about 1, so the angle of total refraction is about 39°. That means that all light beams having an angle of incidence above 39° with respect to the relevant surface of the light-guiding member 1 will be totally reflected back into the material of the light-guiding member 1. The light of the beam will only be coupled out if the light beam has an angle of incidence smaller than 39°.

In this embodiment, the light-guiding member 1 has a substantially right-angled triangular shape in plan view, wherein a shorter side 2 and a longer side 3 of the triangle enclose the substantially right angle 4. In the embodiment shown, the thickness of the plate-like light-guiding member 1 is about 6 mm.

The shorter side 2 is provided with light-coupling means 5 for coupling in light into the light-guiding member 1. The light-coupling means 5 comprise a number of light transmission rods 6 that are positioned parallel to each other in a plane parallel to the plane of the plate-like shape of the light-guiding member 1, at least near that member 1. The light transmission rods 6 and the light-guiding member 1 are produced by one injection molding operation, and therefore they form one integral piece of the same material. FIG. 1 only shows eleven light transmission rods 6, but in practice there may be many more light transmission rods connected to the light-guiding member 1. The light transmission rods 6 may also be located in two of more different parallel planes.

The longer side 3 comprises a coupling-out surface 7 positioned perpendicular to the plane of the plate-like light-guiding member 1. FIG. 2 shows the coupling-out surface 7 in front view. Light will be coupled out from the light-guiding member 1 if the light beam has an angle of incidence with respect to the coupling-out surface 7 of less than 39°, being the angle of total reflection in the described embodiment.

The third side of the triangular shape of the light-guiding member 1, the hypotenuse 8, comprises a number of surfaces 9,10, having alternating directions. All surfaces 9 are positioned parallel to the coupling-out surface 7 and all surfaces 10 are positioned at an angle of 45° to the coupling-out surface 7. The surfaces 9,10 are positioned perpendicularly to the plane of said plate-like shape. FIGS. 3 and 4 show the row of surfaces 9 and 10 with alternating directions.

FIG. 5 is a sectional view taken on the line V-V of FIG. 1 of the light transmission rods 6. A light transmission rod is also called a light transmission tube. However, it is not a “tube” (i.e. a hollow body), but for light it is in fact a tube, because the light is propagated in the material of the tube, and is reflected against the outer surface of it, so it stays in the tube or rod 6.

The light transmission rod 6 may have a round transverse section, so that its shape is cylindrical. However, other shapes of the transverse section are possible, for example a hexagonal or a square shape, in order to facilitate the creation of a beam without space between the light transmission rods 6.

The transverse section of the light transmission rods 6 may also be different over its length, where in one preferred embodiment at least a portion of a light transmission rod 6 has an increasing diameter in the direction of the light-guiding member 1. The light beams will thus become more and more parallel when passing through the light transmission rod. Such an increase in the diameter is preferably applied near the light-guiding member 1 to which the rods 6 are connected, such that preferably the diameter of the light transmission rods 6 near said member 1 is more than 1.5 times, more preferably more than twice, the diameter further away from said light-guiding member. Such an increasing diameter can be easily produced by an injection molding operation of the light transmission rods 6.

Light can be coupled in through a relatively small (short) area at the shorter side 2 by means of the light-guiding member 1 and can be coupled out through a relatively large (long) area i.e. the coupling-out surface 7 at the longer side 3. Depending on the manner of coupling-in of the light into the light transmission rods 6, the direction of the radiation can be given a very small angle with respect to said longitudinal direction. Therefore, the radiation of the coupled-in light entering the light-guiding member 1 through the light transmission rods 6 encloses a small angle with the longitudinal direction of the light transmission rods 6 and is therefore directed substantially parallel to the coupling-out surface 7.

So, the light enters the light-guiding member 1 mainly with a direction parallel to the coupling-out surface 7. Therefore, almost all coupled-in light will hit one of the surfaces 10 with an angle of incidence of about 45°. Since this angle is well above the angle of total reflection (being about 39°), most of the light will be reflected in a direction substantially perpendicular to the coupling-out surface 7, or with a relatively small deviation from that direction. All light having an angle of incidence smaller than 39° will be coupled out through the coupling-out surface 7, apart from some small loss of light caused by the passage through the surface 7.

The light-guiding member 1 functions as an intermediate light guide of which the shorter side 2 of the triangle can be made as short as is required to make use of appropriate light-coupling means 5 and the longer side 3 can have a length corresponding to the length of the oblong lateral surface of a plate-like light-guiding element. The number of surfaces 9,10 along the hypotenuse 8 of the triangle can be as large as is required to achieve an appropriate reflection and distribution of the light.

If the angle of total reflection is greater than in this embodiment because of the use of other materials or another surrounding medium, or if the reflection is disturbed by a less smooth surface, the surfaces 10 and/or also other surfaces of the light-guiding member may be provided with a light-reflecting material. Such a material, or coating, may also protect the relevant surfaces from undesired optical contact with other materials.

Instead of a reflecting coating, a reflecting mirror may be mounted at some distance to the relevant surface, for example surface 10. There are also high-reflection tapes available that can be attached to the surface in order to provide a full reflection of the light back into the material of the light-guiding member 1.

Furthermore, the two parallel surfaces of the light-guiding member (the front surface and the rear surface) may be provided with a coating of a material having a lower refractive index than the material of the light-guiding member 1 itself. Such a coating, or cladding, prevents the surface of the light-guiding material from being contacted by material or from becoming dirty, for example by fingerprints. It is thus counteracted for material with the same or a higher refractive index to make optical contact with the surface of the light-guiding material, and thus counteracted that light can be coupled out unintentionally.

FIGS. 6, 7 and 8 show a number of light transmission rods 6 and a portion of the plate-like light-guiding member 1 to which the light transmission rods 6 are connected. The light transmission rods 6 are parallel adjacent the light-guiding member 1 and positioned in a flat plane, as is shown in FIG. 9, which is a sectional view taken on the line IX-IX in FIG. 6. Further away from the light-guiding member 1, the light transmission rods 6 are positioned closer to each other, and at the end all light transmission rods 6 have become a bundle 14 of parallel rods 6 surrounded by a cylindrical holder 15.

In order to transport light to the light-guiding member 1 through the light transmission rods 6, light has to be coupled in into the light transmission rods 6 at the other ends of these rods 6, i.e. the ends that are not connected to the light-guiding member 1. These ends are present in the cylindrical holder 15. To couple in light, the holder 15 can be placed in front of a lamp or other light source, which is not shown in the drawing. Light with a substantially parallel radiation direction can be obtained by means of a reflector behind the lamp, or a lens in front of the lamp and can be directed to the cylindrical holder 15, so that the light in each light transmission rod 6 substantially has a direction corresponding to the longitudinal direction of the respective rod 6. Therefore, the light will enter the light-guiding member 1 mainly in one direction. If the light-guiding member 1 is a member as shown in FIGS. 1-5, said direction of the light radiation is advantageously as described above. If the light-guiding member 1 is a plate-like light guide for other purposes, however, for example for emitting light through its front side, as will be described below, it is also advantageous to have the light radiation mainly parallel and perpendicular to a lateral surface of the plate like light-guiding member. The light will then be distributed effectively in the light-guiding member and will easily reach locations far away from said lateral surface.

The light transmission rods 6 may have a round transverse section, as is shown in the Figures. However, it may be advantageous to provide the light transmission rods 6 with an alternative transverse sectional shape, for example a hexagonal shape or a square shape. Then the rods 6 can be easily bound together into a bundle without any space between them. In the case of round rods 6, ends of the rods may be heated while being pressed together in order to avoid any clearance between the rods in the cylindrical holder 15. The rods 6 may even be fused (melted) together in the holder 15. However, any space between the light transmission rods 6 in the holder 15 does not disturb the coupling-in of light into the light transmission rods 6, but there may be more loss of light in that case.

In the described embodiment, the holder 15 has a cylindrical shape. However, the holder may also have another shape, for example a rectangular shape, if such a shape corresponds better to the shape of the light source. The light transmission rods 6 may also be divided over more bundles 14, i.e. more holders 15, with the ends of the bundles being located in front of different light sources.

In one preferred embodiment not shown in the Figures, the diameter of the rods varies over their length, such that the diameter increases in a direction away from the light-guiding member 1. As was noted above, such a shape improves the transmission of light in that the transmitted light beams are directed more and more parallel to each other during their transmission.

The light transmission rods 6 may have a diameter between 0.2 mm and 5 mm, preferably between 1 mm and 3 mm, and the distance between the rods 6 near the light-guiding member 1 may be between 0.5 mm and 2 mm. The number of light transmission rods 6 may be high, depending on the requirements. The length of a light transmission rod 6 may also depend on the requirements. In general, the lengths of the light transmission rods 6 are different, to enable each of them to bridge the distance between the lateral surface of the light-guiding member 1 and the cylindrical holder 15 in an appropriate way. This distance may be short where the cylindrical holder 15 with the light source is located near the light transmission member 1, but it is also possible to place the light source and the cylindrical holder 15 far away from the light-guiding member 1, in which case the light transmission rods 6 are arranged in a bundle running from the cylindrical holder 15 to a locations near the light-guiding member 1, where the light transmission rods 6 diverge to their individual location at the lateral surface of the light-guiding member 1.

The light transmission rods 6 as well as the light-guiding member 1 to which the rods 6 are connected are manufactured by means of an injection molding operation. The two parts 1,6 are thus made together, so that they are one piece of material, being polycarbonate in this example of an embodiment, which material allows sufficient flexibility for the light transmission rods 6. Therefore, the light can be guided without any interruption from the light source at a distance from the light-guiding member 1 to this plate-like light-guiding member 1, where its entry is distributed over the full lateral surface of the light-guiding member 1, the radiation of the light being directed substantially perpendicular to this lateral surface.

Said other ends of the light transmission rods 6 are formed into a bundle 14 and surrounded by the holder 15 after the light transmission rods 6, together with the light-guiding member 1, have been manufactured in an injection molding operation. The holder 15 may be a metal or plastic cylinder into which the bundle 14 of light transmission rods 6 is introduced, or alternatively it may comprise two ‘half pipes’ which are joined together around the bundle 14. As an alternative, the holder 15 may consist of tape wound around the bundle 14 of light transmission rods 6.

FIG. 10 shows an embodiment of a light-guiding system comprising a rectangular plate-like light-emitting element 20 and a substantially triangular plate-like light-guiding member 21, similar to the light-guiding member 1 as described above, for which reference is made to FIGS. 1-5.

According to FIGS. 11-13 (side views) and FIGS. 14-15 (sectional views), the plate-like light-emitting element 20 and the light-guiding member 21 are flat, but they may also be curved resulting in a two-or three-dimensional curved shape. Such a shape may, for example, correspond to the shape of a vehicle roof or a part thereof to which the light-guiding system is to be mounted. If there are only relatively weak curves in the plate-like shape, the light will not be coupled out because of the curves.

Light is coupled out through the front surface 22 of the light-emitting element 20. To achieve such a light emission, radiation of light inside the element 20 is given a direction corresponding to an angle of incidence towards the front surface of less than the angle of total reflection. In order to obtain such a direction of light radiation, the rear surface 23 or the front surface 22 may have, at least locally, a certain structure obtained by roughening, embossing or boring of the surface of the material. Another possibility is the introduction of scattering centers, such as refractive pigments, in the material of the light-emitting element 20. Anyway, such means for coupling-out light are known per se. The rear surface 23 of the light-emitting element 20 may be coated with light-reflecting material to prevent light radiation through said back surface 23. It is also possible to mount a mirror at some distance from the rear surface 23, so that light is reflected back into the light-emitting element 20.

In the embodiment shown in FIG. 10, the light-emitting element 20 and the light-guiding member 21 are connected to each other in four locations 24. Between these locations 24 there are three interstices 25, so that the interstices 25 cover a major portion of the area between the light-emitting element 20 and the light-guiding member 21. Although an interstice 25 may extend over a portion of the distance between the front surface 22 and the back surface 23, so that one of the surfaces 22,23 is uninterrupted, in the embodiment shown the interstices 25 extend over the whole thickness of the light-emitting element 20 and the light-guiding member 21, as is clearly shown in FIG. 15. The width of the interstices in this embodiment is about 1 mm. Preferably, the width of the interstices is between 0.05 and 0.15 times the thickness of the light-guiding member 1.

The light-emitting element 20 and the light-guiding member 21 and the light transmission rods 6 are one piece of the same material, in this embodiment polycarbonate, being produced in one injection molding operation. The interstices 25 are also formed during that injection molding process. However, the interstices 25 may alternatively be made afterwards, for example by a material removing operation with a laser beam.

As was stated above about the substantially triangular light-guiding member 1, the light enters the light-guiding member 21 through the light transmission rods 6, the direction of the light radiation being mainly parallel to the longitudinal direction of the rods 6. Then the light is reflected by the surfaces 10 and sent in the direction of the light-emitting element 20, most of the light radiation now having a direction substantially perpendicular to the interstices 25. This light will pass-the interstices 25 with low losses because it passes through both surfaces of the interstice 25. However, light radiation having a direction enclosing a large angle with a line perpendicular to the interstice 25, will not pass the interstice 25 but will be reflected back into the material of the light-guiding member 21. Such light radiation can only pass through the interstice 25 after being reflected in the light-guiding member 21 once or more times, i.e. until its direction enables it to pass through the interstice 25.

So, owing to the interstices 25, the light coupled in into the light-emitting element 21 has a direction whereby it can easily reach locations at a relative large distance to the surface where the light enters the light-emitting element 20. This improves the distribution of the light emission over the front surface 22 of the light-emitting element 20.

Furthermore, the presence of the interstices 25 improves the guidance of light from the light transmission rods 6 to the surface 10 on the right-hand side of FIG. 10, i.e. far away from the rods 6. If a light beam from a lower (in FIG. 10) light transmission rod 6 has a downward inclination, it will be reflected by the surface of the interstice 25 and be directed to the surface 10 on the right-hand side of FIG. 10.

The light-guiding member 21 and/or the light-emitting element 20 and/or the light transmission rods 6 may be provided with a coating having a lower refractive index than the material of said member 21, element 20, or rods 6, respectively. Such a coating, or cladding, prevents the surface of the light-guiding material from being contacted by material or from becoming dirty, for example by fingerprints, when material with the same or a higher refractive index makes optical contact with the surface of the light-guiding material, resulting in undesired coupling-out of light. For example, such a cladding makes it possible to attach a fabric against the front surface of the light-emitting element by means of glue, so that the light can shine through the fabric. The cladding also allows the fixation of the light-guiding system by means of glue.

The embodiments as described above are merely examples of the light-guiding system; a great many other embodiments are possible.

1. A light-guiding system comprising a plate-like light-guiding element having a substantially flat lateral surface and means for coupling in light through said lateral surface, characterized in that said means comprise a light-guiding member substantially having a flat plate-like and triangular shape, wherein a shorter side comprises light-coupling means for coupling in light into said light-guiding member, wherein a longer side comprises a coupling-out surface which faces said lateral surface for coupling in light into said light-guiding element, and wherein the third side of the triangle comprises a number of surfaces that are positioned at an angle to the direction of said third side, all said surfaces being perpendicular to the plane of said plate-like shape.

2. A light-guiding system as claimed in claim 1, characterized in that the plate-like light-guiding member has a substantially right-angled triangular shape, wherein said shorter side and said longer side of the triangle enclose the substantially right angle, and wherein said third side is the hypotenuse of the triangle, which side comprises said number of surfaces, said surfaces being positioned at an angle of about 45° to said coupling-out surface.

3. A light-guiding system as claimed in claim 1, characterized in that said third side comprises a number of surfaces having alternating directions, at said angle to the direction of said third side and substantially perpendicular to said shorter side.

4. A light-guiding system as claimed in claim 1, characterized in that at least said surfaces positioned at an angle to the direction of said third side are provided with a light-reflecting material.

5. A light-guiding system as claimed in claim 1, characterized in that the light-guiding member has a thickness between 0.5 mm and 15 mm, preferably between 2 mm and 7 mm.

6. A light-guiding system as claimed in claim 1, characterized in that at least a portion of one or both surfaces of said light-guiding member, which surfaces are parallel to said plane, are provided with a coating of a material having a lower refractive index than the material of the light-guiding member.

7. A light-guiding system as claimed in claim 1, characterized in that said light-coupling means for coupling in light into said light-guiding member comprise a number of light transmission rods, each of said light transmission rods having an end which is connected to a surface at said shorter side of said light-guiding member.

8. A light-guiding system as claimed in claim 7, characterized in that said light-guiding member and said light transmission rods are one piece of the same material.

9. A light-guiding system as claimed in claim 7, characterized in that the other ends of the light transmission rods are bound together so as to form a member for coupling in light into said light transmission rods.

10. A light-guiding system as claimed in claim 1, characterized in that said plate-like light-guiding element has means for emitting light through at least a part of its front surface.

11. A light-guiding system as claimed in claim 1, characterized in that at least a portion of the front side and/or the rear side of the plate-like light-guiding element is provided with a coating having a lower refractive index than the material of the light-guiding element.

12. A light-guiding system as claimed in claim 1, characterized in that said light-guiding element and said light-guiding member are one piece of the same material, said element and said member each extending at a side of a flat plane, wherein an interstice lying in said plane and extending over at least a major portion of said coupling-out surface is present between said lateral surface of said light-guiding element and said coupling-out surface of said light-guiding member.

13. A light-guiding member as described in claim 1, characterized by a substantially flat plate-like and triangular shape, wherein a shorter side comprises light-coupling means for coupling in light into said light-guiding member, wherein a longer side comprises a coupling-out surface which may face a surface for coupling in light into a light-guiding element, and wherein the third side of the triangle comprises a number of surfaces that are positioned at an angle to the direction of said third side, all said surfaces being perpendicular to the plane of said plate-like shape.

14. A method of guiding light into a plate-like light-guiding element having a flat lateral surface, wherein light is coupled in through said lateral surface, characterized in that light is coupled in by a light-guiding member substantially having a flat plate-like and triangular shape, wherein light is coupled in into said light-guiding member through a shorter side of the triangle by light-coupling means, and wherein a longer side of the triangle comprises a coupling-out surface which faces said lateral surface for coupling in light into said light-guiding element, and wherein the third side of the triangle comprises a number of surfaces that are positioned at an angle to the direction of said third side, all said surfaces being perpendicular with respect to the plane of said plate-like shape, so that the light is reflected by the surfaces at an angle to the direction of the third side and is thus directed to said coupling-out surface and coupled in into said light-guiding element.
